(19) United States
(12) Patent Application Publication
(10) Pub. No.: US 2026/0220474 A1
(43) Pub. Date: Jul. 30, 2026

(54) AUTOMATED AGENT BEHAVIOR CONTROL USING LARGE LANGUAGE

(71) Applicant: Salesforce, Inc., San Francisco, CA (US)

(72) Inventors: Manjeet Singh, San Francisco, CA (US); Christopher Todd Clark, Raleigh, NC (US); Bin Bi, Bellevue, WA (US); Deepak Mukunthu, Bellevue, WA (US); Sky Chen, Palo Alto, CA (US)

(21) Appl. No.: 19/041,159

(22) Filed: Jan. 30, 2025

(51) Int. Cl. G06N 3/092

(52) U.S. Cl. CPC G06N 3/092

(57) ABSTRACT

A large language model (LLM) service for controlling LLM agents via an LLM may include obtaining, via a user interface, instructions for a first LLM, that is configured for agent evaluation, to evaluate inputs and outputs of LLM agents. The LLM service may obtain an input to an LLM agent. The LLM service may monitor the input to the LLM agent to evaluate whether the input to the LLM agent is in accordance with the instructions. The LLM service may output, to the LLM agent, the input based on evaluation of the input. The LLM service may obtain, from the LLM agent, an output in response to the input and monitor the output of the LLM agent to evaluate whether the output from the LLM agent is in accordance with the instructions. The LLM service may output the output from the LLM agent based on evaluation of the output.

### FIELD OF TECHNOLOGY

The present disclosure relates generally to database systems and data processing, and more specifically to automated agent behavior control using large language models.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, the cloud platform, or another platform, may utilization of one or more artificial intelligence (AI) agents. In some cases, AI agents may be deployed across various different industries and can be designed to perform a wide range of tasks, by interacting with users and executing actions. In some examples, AI agents may autonomously execute actions in response to user inputs, prompts, queries, or any combination thereof. However, the complexity and autonomy of these AI agents may result in relatively significant challenges in ensuring their behavior aligns with intended guidelines and ethical standards.

### BRIEF DESCRIPTION OF THE DRAWINGS

FIG. 1 illustrates an example of a system for agent control via a large language model (LLM) system that supports automated agent behavior control using LLMs in accordance with aspects of the present disclosure.

FIG. 2 shows an example of a computing system that supports automated agent behavior control using LLMs in accordance with aspects of the present disclosure.

FIG. 3 shows an example of a user interface that supports automated agent behavior control using LLMs in accordance with aspects of the present disclosure.

FIG. 4 shows an example of a process flow that supports automated agent behavior control using LLMs in accordance with aspects of the present disclosure.

FIG. 5 shows a block diagram of an apparatus that supports automated agent behavior control using LLMs in accordance with aspects of the present disclosure.

FIG. 6 shows a block diagram of an LLM that supports automated agent behavior control using LLMs in accordance with aspects of the present disclosure.

FIG. 7 shows a diagram of a system including a device that supports automated agent behavior control using LLMs in accordance with aspects of the present disclosure.

FIG. 8 shows a flowchart illustrating methods that support automated agent behavior control using LLMs in accordance with aspects of the present disclosure.

### DETAILED DESCRIPTION

In some systems, users may utilize artificial intelligence (AI) systems and services for various services across different industries. For example, users may utilize one or more AI agents that are associated with one or more AI or machine learning (ML) models (e.g., AI/ML models). In some cases, an AI agent may be associated with a type of AI/ML model such as a large language model (LLM). An LLM may be a type of AI/ML model that is trained a relatively large quantity of data and is designed to process and respond to natural language inputs. In some cases, an AI agent may also be referred to as an LLM agent. Such LLM agents may be designed to perform a wide range of tasks, from customer service to sales and marketing, by interacting with users and executing actions. In some cases, the complexity and autonomy of LLM agents may result in relatively significant challenges in ensuring the behavior of the LLM agents aligns with intended guidelines and ethical standards. In some examples, monitoring and controlling LLM agent behavior may rely on manual analysis and intervention. Further, such control may involve a user or system reviewing the actions and decisions made by LLM agents after execution of the actions, which can lead to delayed responses and potential harm before corrective measures are implemented. Additionally, or alternatively, current systems may lack the capability to provide real-time feedback and adjustments

In accordance with the techniques of the present disclosure, a LLM service may obtain, via a user interface of an agent (e.g., LLM agent) builder platform, a set of instructions for a first LLM that is configured for LLM agent evaluation. The set of instructions may indicate for the first LLM to evaluate both inputs to LLM agents and outputs from LLM agents. Moreover, the LLM agents may be established via the agent builder platform and the LLM agents may be associated with a first tenant of a set of tenants that utilize the agent builder platform. The LLM agent service may obtain, from a user of a first tenant, an input to a first LLM agent that is associated with a second LLM different from the first LLM. The LLM service may then monitor, via the first LLM, the input to the first LLM agent to evaluate whether the input is in accordance with the set of instructions. In response to the evaluation, the LLM service may output input to the first LLM agent for execution by the first LLM agent. The LLM service may then obtain an output from the first LLM agent in response to the input from the user. The LLM service may monitor, via the first LLM, the output from the LLM agent to evaluate whether the output is in accordance with the set of instructions. In response to the evaluation, the LLM service may output, to the user, the output from the LLM agent. Thus, the LLM service may configure the first LLM to evaluate both inputs and outputs to LLM agents to ensure accurate, efficient, and reliable communications and interactions with LLM agents. Moreover, the LLM service may evaluate the inputs and outputs in real-time which can result in a decrease in delay of LLM agent interactions and LLM agent services.

In some cases, the LLM service may store the inputs and outputs of LLM agents and messages from the first LLM associated with evaluating the LLM agents. For example, the stored inputs and output may be used for further analysis and evaluation by users and LLMs and can be utilized to finetune the training of the first LLM. In some examples, in response to an evaluation, the first LLM may output a positive indication if the evaluation of an input or output is in accordance with the set of instructions or a negative indication if the evaluation of an input or output is not in accordance with the set of instructions. In cases where the first LLM outputs a negative indication, the first LLM may request the user to provide a second input or request that the LLM agent generate a second output. In some examples, the first LLM may also determine to request for human intervention in response to an evaluation or determine to terminate an interaction.

Aspects of the disclosure are initially described in the context of an environment supporting an on-demand database service. Additional aspects of the disclosure are described with reference to a computing system, a user interface, and a process flow. Aspects of the disclosure are further illustrated by and described with reference to apparatus diagrams, system diagrams, and flowcharts that relate to automated agent behavior control using LLMs.

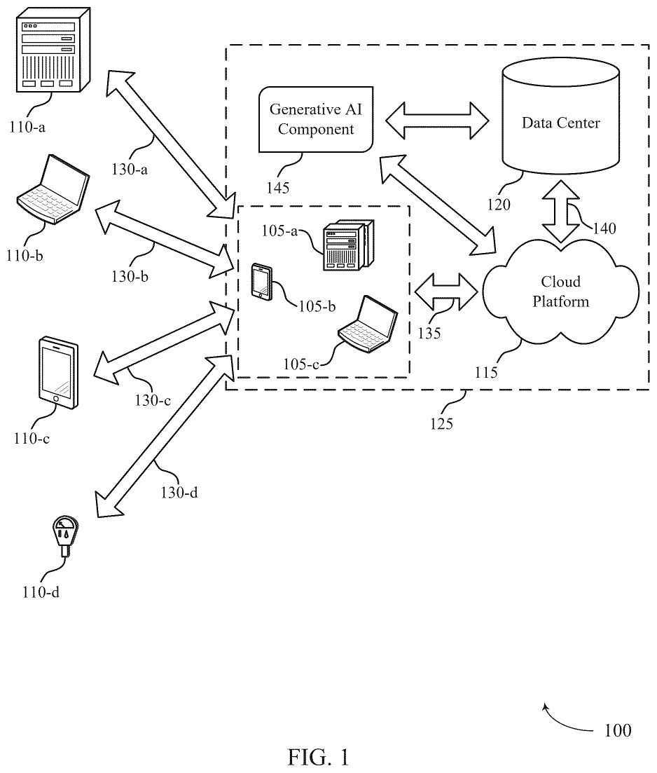

FIG. 1 illustrates an example of a system 100 for cloud computing that supports automated agent behavior control using LLMs in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative AI component 145. The generative AI component 145 may be an example or a component of an LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples of the system 100, the generative AI component 145 may enable users of the system to utilize one or more AI or LLM agents. For example, users may configure and interact with LLM agents via user interfaces of cloud clients 105, contacts 110, or both. In some examples, LLM agents may be utilized for a relatively wide range of tasks or use cases and the LLM agents may perform actions for users autonomously. However, the complexity and autonomy of LLM agents may result in challenges in ensuring that LLM agents maintain configured behaviors and follow guidelines and ethical standards. For example, an LLM agent may obtain an input from a user that request the LLM agent to perform a task that is against a set of guidelines for the LLM agent. However, the user may configure the input in fashion such that the LLM agent is unable to detect that one or more guidelines are being violated. Moreover, the LLM agent may violate one or more guidelines when generating outputs for users in response to inputs that follow guidelines or inputs that violate guidelines. In some cases, to monitor the inputs and outputs, a user may manually evaluate the inputs and outputs which may result in delayed responses and potential harm if a manual evaluation is performed after execution of an input that violates guidelines or a generation of an output that violates guidelines. Moreover, the system 100 may be configured to evaluate inputs and outputs after execution and generation as the system 100 may lack the capability to provide real-time feedback and adjustments, which can result in a decrease in the accuracy, efficiency, and reliability of the LLM agents of the system 100.

In accordance with the techniques of the present disclosure, the generative AI component 145 may configure and train a first LLM for evaluating both inputs to LLM agents and outputs from LLM agents in real-time. For example, the generative AI component 145 may configure the first LLM to monitor for inputs to LLM agents and for outputs from LLM agents and implement corrective measures to prevent inputs and outputs from violating guidelines for the LLM agents. In some examples, the first LLM may monitor the inputs and outputs by monitoring metadata associated with the inputs and outputs. The generative AI component 145 may further store example inputs and outputs within a cloud platform 115 or data center 120 to enhance the training of the first LLM. For example, the first LLM may be trained or finetuned via previous LLM agent interaction histories that are manually labeled, via training data generated by users or LLMs based on the instructions or guidelines for an LLM agent, or a combination thereof.

Moreover, the set of instructions for the first LLM may be provided by users within an agent builder platform. For example, a user may input a set of instructions for the first LLM within the agent builder platform to indicate guidelines for inputs and outputs, how the first LLM should evaluate the inputs and outputs, and to indicate actions the first LLM can perform in response to an input or output that violates the instructions or guidelines. In some cases, the actions may include prompting a user to provide a different input, prompting an LLM agent to regenerate an output in response to a user input, calling for human intervention, or any combination thereof. For example, in response to an LLM agent generating a response to a user to accept a deal or price negotiation above a threshold price, the first LLM may obtain the response and call for human intervention to cause a human user to approve of the price. In another example, if a user attempts to get an LLM agent to perform an action that violates a set of instructions or guidelines above a quantity of times, the first LLM may terminate the interaction between the user and the LLM agent, call for human intervention, or a combination thereof. Thus, the techniques of the present disclosure may ensure that interactions with LLM agents are in accordance with guidelines, instructions, and ethical standards both at the input layer and output layer in real-time. Moreover, the techniques of the present disclosure may also finetune the training of the LLM for evaluation to improve the monitoring performance of the LLM which can result in an increase in the efficiency, reliability, and accuracy of LLM agents within the system 100.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

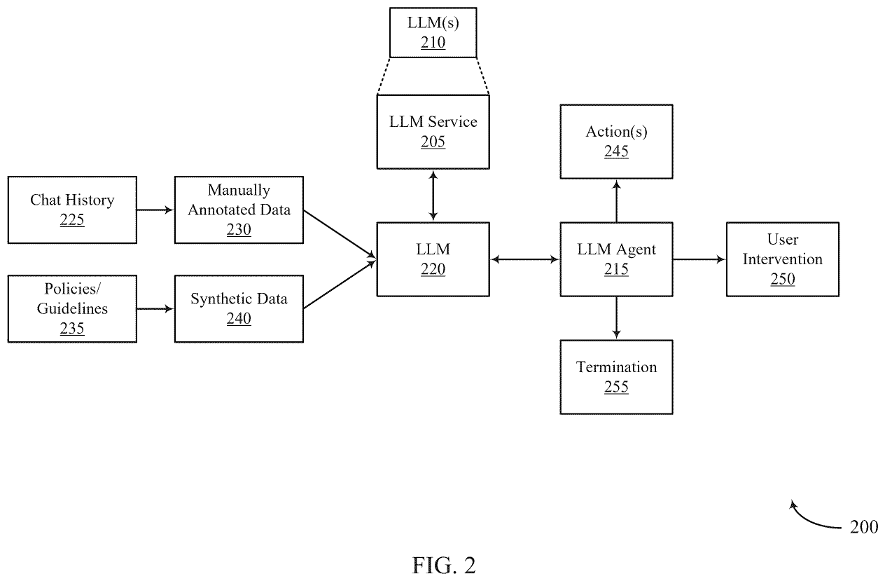

FIG. 2 shows an example of a computing system 200 that supports automated agent behavior control using LLMs in accordance with aspects of the present disclosure. In some examples, the computing system 200 may implement or be implemented by the system 100. For example, the computing system 200 may include an LLM service 205 associated with a set of LLMs 210 for LLM agents 215 and an LLM 220, which may represent examples of corresponding devices described herein with reference to FIG. 1. Moreover, set of LLMs 210 may be LLMs 210 for LLM agents 215 and the LLM 220 may be for evaluation of inputs to the LLM agents 215 and outputs from the LLM agents 215.

In some examples, LLM agents 215 (e.g., co-pilots) may provide unexpected outputs. For example, an LLM agent 215 associated with an LLM 210 may provide an incorrect output to a user (e.g., a customer) in response to an input from the user. In some cases, after the LLM agent 215 provides the incorrect output, it may be relatively difficult to determine why the LLM agent 215 generated an incorrect output without evaluating and analyzing the LLM agent 215 afterwards (e.g., after the incorrect output is generated and proved to the user). In some cases, LLM agents 215 may be configured using reasoning and acting (ReAct) techniques which can cause LLM agents 215 to deviate from intended and expected behaviors. ReAct techniques may train LLM agents 215 to alternate between reasoning about a situation and performing actions by following a think, act, observe pattern. In some cases, such techniques can cause logical errors, misinterpretation of observations, context loss, or hallucinations (e.g., generation of false content), thus resulting in unexpected behaviors. Moreover, ensuring that LLM agents 215 adhere to principles and guidelines may be relatively challenging in complex scenarios where the quantity of guidelines for an LLM agent 215 may be relatively large. Further, LLM agents 215 may have difficulty in maintaining alignment between ethical standards and regulatory expectations (e.g., requirements). For example, an LLM agent 215 may be unable to determine or may have difficulty determining a best action when an ethical standard and regulatory guideline or instruction seem contradictory. Isome cases, there may also be a lack of scalable techniques for personalized and industry-specific LLM agent 215 alignments. Moreover, LLM agents 215 should be continuously improved to enhance error correction in AI decision-making processes within the computing system 200.

In accordance with the techniques of the present disclosure, the LLM service 205 may configure and train an LLM 220 to monitor LLM agent 215 behavior during function calling and to interject (e.g., interrupt or halt) to stop and correct incorrect behavior. In some cases, the LLM 220 may be configured to be integrated with one or more LLM agents 215 to support real-time monitoring. For example, the LLM service 205 may configure the LLM 220 to monitor and analyze ReAct internal conversations and actions performed by LLM agents 215 in real-time. In some cases, the LLM 220 may also be associated with an intervention system to provide recommendations to users, LLM agents 215, or both when the LLM 220 detects deviations. Additionally, or alternatively, the computing system 200 may have a fine-tuning mechanism to ensure that the LLM 220 is trained with relatively high-quality annotated real-world LLM agent 215 interactions (e.g., ReAct conversations). Further, the LLM 220 may provide a scalable framework for enforcing personalized and industry-specific guidelines or principles.

In some examples, the techniques of the present disclosure may assist in improving a monitoring pipeline (e.g., a retrieval augmented generation (RAG) pipeline used to improve the accuracy of LLM agents 215) which may be associated with multiple failure points. For example, content may be retrieved incorrectly, LLMs 210 may fail to hydrate an augmented prompt with retrieved content, LLMs 210 may fail to utilize retrieved content for generating a response, and the response may fail to answer a respective query from a user. In some cases, as part of a RAG pipeline, in an offline phase, data may be loaded, chunked, embedded into vectors, and then stored for retrieval by an LLM 210. However, in some cases, the embedding may be imprecise which can result in missing content. Further, during an online phase of the RAG pipeline, a query may be obtained from a user via a prompt, the query may be embedded into vectors, data may be retrieved from the stored data, an augmented prompt can be generated using the embedded query and retrieved data, and an LLM 210 can generate and output a response to the query. However, the query may be ineffective, thus leading to a lack of content or relevant content being retrieved, a lack of content being hydrated (e.g., inserted) into an augmented prompt, a lack of content being used for a response generation, and the response failing to answer the query.

In some examples, a response to a query generated by an LLM 210 may be associated with an answer relevance, a context relevance, and a faithfulness of the response. The answer relevance may be how pertinent the generated response is to a given prompt. The context relevance may be a relevance of the retrieved context that is calculated based on the query and the context of the data retrieved. The faithfulness of a response may be based on the factual consistency of a generated response against the given context.

To improve the answer relevance, the context relevance, and the faithfulness of a response generated by an LLM 210 of an LLM agent 215, the techniques of the present disclosure may ensure that the LLM 220 monitors the behavior of the LLM agent 215 and performs risk mitigation as expected or required. In some examples, to train the LLM 220, the LLM service 205 may use a chat history 225 of LLM agent 215 interactions with users or other LLM agents 215 to generate a set of manually annotated data 230. For example, the chat history 225 may include a previous set of messages from one or more LLM agents 215 and one or more users. Further, one or more messages of the previous set of messages may include an annotation indication whether the one or more messages are in accordance with a set of instructions for the LLM 220 (e.g., instructions for the LLM 220 to evaluate both inputs and outputs of LLM agents 215). Thus, the set of manually annotated data 230 may include example messages that are prelabelled as being in accordance with instructions or out of accordance with instructions. For example, a first data item of the set of manually annotated data 230 may be associated with an input from a user that is in accordance with the set of instructions and a second data item of the set of manually annotated data 230 may be associated with an output from an LLM agent 215 that is not in accordance with the set of instructions. In some cases, the first data item may thus be labeled with a first label associated with being in accordance with a set of instructions and the second data may be labeled with a second label associated with not being in accordance with the set of instructions. In some examples, the set of manually annotated data 230 may also include one or more indications of which instructions are violated, how the instructions are violated, and indications of one or more mitigation recommendations for data items that are not in accordance with the set of instructions.

In another example, to train the LLM 220, the LLM service 205 may use a set of policies/guidelines 235 to generate a set of synthetic data 240. In some cases, the set of policies/guidelines 235 may include instruction sets of what a user, LLM agent 215, or both are allowed to do and not allowed to do. For example, the set of policies/guidelines 235 may indicate that a LLM agent 215 is not allowed to send electronic communications (e.g., emails, text messages, and the like) directly to users (e.g., customers). Using the set of policies/guidelines 235, an LLM 210 of the LLM service 205 may generate the set of synthetic data 240. In some cases, the set of synthetic data 240 may also be referred to as a set of training data. For example, the set of synthetic data 240 may include a set of messages from users and from LLM agents that are labeled as being in accordance with the set of policies/guidelines 235 or not in accordance with the set of policies/guidelines 235. In some examples, to generate the set of synthetic data 240, the LLM service 205 may use an LLM 210 and prompt the LLM 210 to generate a set of messages that are in accordance with the set of policies/guidelines 235 and a set of messages that are not in accordance with the set of policies/guidelines 235.

Utilizing the set of manually annotated data 230 and the set of synthetic data 240, the LLM service 205 may train the LLM 220 to evaluate both inputs to LLM agents 215 and outputs from LLM agents 215. For example, based on obtaining the set of manually annotated data 230 and the set of synthetic data 240, the LLM 220 may determine actions, patterns, or behaviors that are not in accordance with a set of instructions for an LLM agent 215 (e.g., for an LLM 210 of an LLM agent 215). Further, based on the LLM 220 being trained to detect inputs and outputs that are not in accordance with a set of instructions, the LLM 220 may enable LLM agents 215 to perform one or more actions 245, call for user intervention 250, or call for a termination 255 of an interaction.

In some examples, in accordance with the techniques of the present disclosure, if the LLM 220 detects that an input to an LLM agent 215 or an output from an LLM agent 215 is not in accordance with a set of instructions, one or more actions 245 may be executed. In some cases, for inputs to an LLM agent 215 that are not in accordance with the set of instructions, the LLM 220 or the LLM agent 215 may execute an action 245 to prompt a user to provide a different input (e.g., a second input) to the LLM agent 215. In response, the user may provide a second input to the LLM agent 215 which may be evaluated by the LLM 220.

In some cases, when the LLM 220 monitors the input to the LLM agent 215, the LLM 220 may output, to the LLM service 205, a positive indication based on the evaluation of the input to the LLM agent 215 indicating that the input is in accordance with the set of instructions, or a negative indication based on the evaluation of the input to the LLM agent 215 indicating that the input violates (e.g., is not in accordance with) the set of instructions. In some cases, the LLM service 205 may obtain, from the LLM 220, an indication of one or more actions for a first user associated with a first tenant to perform to generate a second input that is in accordance with the set of instructions based on the LLM service 205 obtaining the negative indication for the input to the LLM agent 215. Further, the LLM service 205 may output, to the first user associated with the first tenant, the negative indication and the indication of the one or more actions for the first user to generate the second input. In response, the user may generate a second input that is based on the first input and in accordance with the one or more actions indicated by the LLM 220 via the LLM service 205. In some cases, if the LLM 220 determines that the second input also violates the set of instructions, the LLM 220 may output a second negative indication. If the LLM 220 determines that the second input is in accordance with the set of instructions, the LLM 220 may output the positive indication to trigger the LLM service 205 to provide the input to the LLM agent 215 for execution. Additionally, or alternatively, if the LLM 220 detects that a subsequent input continues to violate the set of instructions such that an input threshold is satisfied, the LLM 220 may call for end the interaction between the user and the LLM agent 215.

In some other cases, for outputs of LLM agents 215 that are not in accordance with the set of instructions, the LLM 220 may execute an action 245 for the LLM agent 215 to regenerate the output. In some examples, the LLM 220 may indicate that the LLM agent 215 should perform one or more different actions 245 or call one or more different functions when regenerating the output. For example, if an LLM 210 of the LLM agent 215 used a first prompt to generate a response, the action 245 may indicate for the LLM 210 of the LLM agent 215 to utilize a second prompt that is different from the first prompt for regenerating the response. In some cases, the second prompt may include similar instructions as the first prompt with some additions to reduce the likelihood of the output violating the set of instructions. In some other cases, the second prompt may include different instructions from the instructions of the first prompt.

In some cases, when the LLM 220 monitors the output from the LLM agent 215, the LLM 220 may output, to the LLM service 205, a positive indication based on the evaluation of the output from the LLM agent 215 indicating that the output is in accordance with the set of instructions, or a negative indication based on the evaluation of the output from the LLM agent 215 indicating that the output violates (e.g., is not in accordance with) the set of instructions. In some cases, the LLM service 205 may obtain, from the LLM 220, an indication of one or more actions for an LLM 210 associated with the LLM agent 215 to perform to generate a second output that is in accordance with the set of instructions based on the LLM service 205 obtaining the negative indication for the input to the LLM agent 215. Further, the LLM service 205 may output, to the LLM 210 associated with the LLM agent 215, the negative indication and the indication of the one or more actions for the LLM 210 to generate the second output. In response, the LLM 210 associated with the LLM agent 215 may generate a second output that is based on the first output and in accordance with the one or more actions indicated by the LLM 220 via the LLM service 205. In some cases, if the LLM 220 determines that the second output also violates the set of instructions, the LLM 220 may output a second negative indication. If the LLM 220 determines that the second output is in accordance with the set of instructions, the LLM 220 may output the positive indication to trigger the LLM service 205 to provide the input to the user that provided the input that the output is in response to. Additionally, or alternatively, if the LLM 220 detects that a subsequent output continues to violate the set of instructions such that an output threshold is satisfied, the LLM 220 may call for end the interaction between the user and the LLM agent 215.

In some examples, in response to the LLM 220 detecting an input to the LLM agent 215 or an output from the LLM agent 215 violating the set of instructions (e.g., not in accordance with the set of instructions), the LLM 220 may call for a user intervention 250. In some cases, the user intervention 250 may include the LLM 220 pausing an interaction between a user and the LLM agent 215 and calling for a human user to review the interaction. In some examples, the LLM 220 may call for the user intervention 250 based on an input to the LLM agent 215 expecting a human user approval before execution, an output from the LLM agent 215 expecting a human user approval before being provided to a user, or a combination thereof. For example, the LLM agent 215 may require human user approval of an action via the user intervention 250 for an action that is associated with a monetary price above a threshold (e.g., an action associated with more than $100). Additionally, or alternatively, the LLM 220 may detect an input to the LLM agent 215 or an output from the LLM agent 215 violating the set of instructions and the LLM 220 may trigger for the LLM agent 215 to perform a termination 255 of an interaction. In some cases, a termination 255 of an interaction may include ending a conversation between a user and the LLM agent 215 based on the violation of the set of instructions.

Therefore, in accordance with the techniques of the present disclosure, the LLM 220 may run concurrently with the LLM agent 215 and monitor the ReAct processes of the LLM agent 215. For example, the LLM 220 may continuously analyze the internal conversations and planned actions of the LLM agent 215 to determine if the conversations, actions, or both are against predefined principles. Moreover, when deviations are detected, the LLM 220 may interject with corrective recommendations. In some cases, the LLM 220 may then incorporate the recommendations to align subsequent actions with guiding principles. For example, when a deviation of an output is detected, the LLM 220 may recommend for the LLM agent 215 to regenerate the output.

In some examples, a correction or recommendation may also be associated with a user intervention 250. For example, a correction may include a user being called to manually type out a correct tool invocation for the LLM agent 215 as if the LLM agent 215 outputted the invocation and then triggering the LLM agent 215 to resume operations. In another example, a correction may be associated with recommending actions 245 to a LLM agent 215 associated with calling functions. For example, in response to an output being generated that violates a set of instructions, the LLM 220 may trigger the LLM agent to call a function with a different argument (e.g., argument X instead of argument Y) and to update a prediction or output accordingly. In some other examples, the correction or recommendation may be associated with updating the instructions or state of the LLM agent 215 at the point in time of the violation of the set of instructions. After updating the instructions or state of the LLM agent 215, the LLM agent 215 may be rerun using the updated instructions or state.

Additionally, or alternatively, the recommendation may be to trigger a user intervention 250. In some cases, to integrate user inputs, LLM agents 215 may be configured with when and how LLM agents 215 should ask for help from users rather than relying on users. Thus, the techniques of the present disclosure may enable users (e.g., human users) from being “in-the-loop” to “on-the-loop.” For users to be “on-the-loop” of an LLM agent 215, the techniques of the present disclosure may enable LLM agents 215 the capability to show or illustrate users a set of intermediate steps or actions performed by an LLM agent 215. Thus, a user may have the capability to pause a workflow, provide feedback or updates, and then resume the workflow of the LLM agent 215. In some cases, “in-the-loop,” or human-in-the-loop (HIL) interactions may be utilized for agentic systems. Agentic systems may be examples of AI systems that can adapt to additional information, learn based on previous actions, experiences, and information, and execute decisions or actions. Having a LLM agent 215 wait for a human or user input may be a relatively common interaction pattern that can allow the LLM agent 215 to ask a user clarifying questions and await for input before proceeding. For example, an LLM agent 215 may be capable of executing simple tasks but may request for user input on relatively more complex tasks to ensure that the tasks are completed correctly.

Further, in accordance with the techniques of the present disclosure, the LLM 220 for evaluation of inputs to LLM agents 215 and outputs from LLM agents 215 may be utilized for various different industries. For example, the techniques of the present disclosure may be utilized in industries such as finance, healthcare, legal, marketing, among others. Moreover, the LLM 220 and the LLM agents 215 may be configured to be tenant or industry specific. For example, a first tenant utilizing an LLM agent 215 may have a different set of instructions for evaluation of inputs to the LLM agent 215 and outputs from the LLM agent 215 than a second tenant. Thus, in accordance with the techniques of the present disclosure the set of instructions for the LLM 220 may be based on data associated with a respective tenant. For example, the set of instructions for the LLM 220 may be based on data associated with a tenant (e.g., CRM data or data within a data platform associated with the tenant). Moreover, the set of instructions for the LLM 220 may be associated with a first tenant based on the set of instructions for the LLM 220 being for evaluation of LLM agents 215 associated with the first tenant.

Further, when evaluating the inputs to LLM agents 215 and outputs from LLM agents 215, in accordance with the techniques of the present disclosure the LLM 220 may evaluate for RAG quality metrics. For example, the LLM 220 may evaluate whether a set of retrieved context is relevant to a query, whether a response (e.g., output) is supported by the retrieved context, and whether a response is relevant to the query (e.g., whether the response accurately answers the query). In some cases, to obtain such information, the LLM 220 may be configured with a set of RAG metrics, trust metrics, and LLM agent 215 metrics to observe. In some examples, the LLM 220 may observe whether the metrics are satisfied by obtaining user feedback, collecting inputs and outputs, retrieving data, and observing traces and logs.

Based on obtaining such information and performing one or more operations to determine if the LLM agents 215 are complying with and satisfying one or more metrics, the LLM service 205 may store the determinations. In some cases, the LLM service 205 may store a determination of whether an input/output satisfies one or more metrics within data objects of a data platform. In some examples, the data platform may be a multi-tenant data platform and the LLM service 205 may store the data associated with the determinations within data objects that are associated with a tenant of a user that initiated an interaction with an LLM agent 215. Further, when storing the information within data objects, the information may be stored with one or more data objects, such as an evaluation metric name data object, an evaluation metric result data object, a retrieved context request data object, and a retrieved context response data object. In some cases, the multi-tenant data platform may further use one or more LLMs to generate insights or analysis to further enhance the training of LLMs associated with the LLM service 205 and LLM agents 215. In some other examples, the data platform may be associated with a respective tenant and the tenant may use the information for display within report, dashboard, or another user interface associated with the data platform. Moreover, a data platform may also be referred to as a data cloud.

In some examples, when evaluating the one or more RAG metrics, the LLM 220 may evaluate for faithfulness, correctness, conciseness, completeness, relevance, citations or references, retrieved contexts precision and recall, or any combination thereof. For faithfulness, the LLM 220 may evaluate whether the RAG response (e.g., the LLM agent 215 output) is faithful to the retrieved data (e.g., data chunks) by comparing the response and the retrieved documents or data chunks. For correctness, the LLM 220 may evaluate whether the response is the same or comparable with the ground-truth answer. A ground-truth answer may represent a verified, absolutely correct solution or data point that serves as the definitive reference standard against which other answers or predictions can be measured. For conciseness, the LLM 220 may evaluate whether a response is concise, short and clear, and expresses important and essential information while avoiding unnecessary details and wordiness. For completeness, the LLM 220 may evaluate whether the response includes all the important information expected to answer the query. For relevance, the LLM 220 may evaluate whether the response is relevant enough to answer the query. For citations/references. the LLM 220 may measure the accuracy and usefulness of citations included in the response. For example, the LLM 210 of an LLM agent 215 may include one or more citations or references within a response to indicate where the information used in the response or used for predictions or inferences by the LLM 210 is from (e.g., to indicate the sources used for generating the response). For retrieved context precision and recall, the LLM 220 may measure the precision and recall of the retrieved data used by an LLM 210 of an LLM agent 215 to generate a response.

Additionally, or alternatively, in some cases, to improve the function of the LLM 220 to evaluate the inputs to LLM agents 215 and outputs from LLM agents 215 in accordance with the techniques of the present disclosure, the LLM 220 may be fine-tuned for evaluation. For example, the computing system 200 may collect real-world ReAct conversations or interactions between users and LLM agents 215 that may be used for further training of the LLM 220. Moreover, computing system 200 may utilize relatively high-quality annotations of training data to identify inputs and outputs that violation instructions. Further, as users interact with the LLM agents 215, the LLM service 205 may retrain and fine-tune the LLM 220 for evaluating the interactions with the LLM agents 215. For example, the LLM service 205 may store previous interactions including both inputs, outputs, and messages from the LLM 220 to allow the LLM 220 to train and learn based on previous experiences. Moreover, the LLM 220 may learn based on user feedback. For example, users may provide feedback on the output from an LLM agent 215. In some cases, the users may provide feedback via a thumbs up or down indication, text-based feedback that includes one or more comments, and the like. Further, the techniques of the present disclosure may implement a feedback loop for continuous improvement of both the LLM 220 and the LLM agent 215. In some cases, the LLM 220 may also be capable of supporting customized metrics (e.g., grading outputs) to enhance the customization of the evaluation of LLM agents 215 for tenants. Moreover, the techniques of the present disclosure may provide for a relatively faster response time on metrics score generations using the LLM 220 that is finetuned for LLM agent 215 evaluation. Additionally, or alternatively, the LLM 220 that is finetuned for LLM agent 215 evaluation may have a relatively longer context length, thus enabling the LLM 220 to more accurately and effectively evaluate inputs to LLM agents 215 and outputs from LLM agents 215.

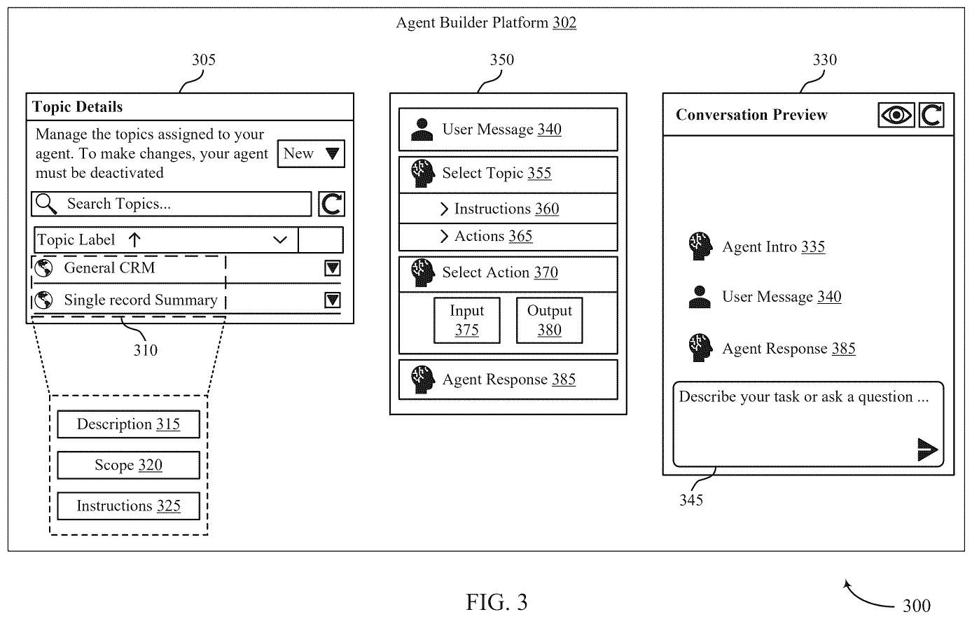

Thus, in accordance with the techniques of the present disclosure, the LLM service 205 may configure the LLM 220 to evaluate LLM agents 215 to ensure efficient, accurate, and reliable interactions with LLM agents 215. In some cases, LLM agents 215 and the LLM 220 for evaluating the LLM agents 215 may be configured or established via an agent builder platform. In some cases, multiple tenants may utilize the agent builder platform to establish LLM agents 215 for the tenant and can customize the LLM 220 for evaluating the LLM agents 215 that are associated with the tenant by utilizing tenant-specific data. Further descriptions of the agent builder platform and a corresponding user interface may be described elsewhere herein, such as with reference to FIG. 3.

FIG. 3 shows an example of a user interface 300 that supports automated agent behavior control using LLMs in accordance with aspects of the present disclosure. In some examples, the user interface 300 may implement or be implemented by the system 100, the computing system 200, or a combination thereof. For example, the user interface 300 may be an example of a user interface 300 for an agent builder platform 302 for configuring and utilizing one or more LLM agents and LLMs for evaluating the inputs to LLM agents and outputs from LLM agents, as described with reference to FIGS. 1 and 2.

In accordance with some of the techniques of the present disclosure, the user interface 300 of agent builder platform 302 may include a topic details portion 305 that may enable users to generate one or more topics 310 for LLM agents. In some cases, the users may input a description 315, scope 320, and instructions 325 for each topic 310 of an LLM agent. For example, a user may configure a topic 310 to be associated with CRM data of a tenant associated with the user and a corresponding LLM agent to perform operations associated with the topic 310. In some cases, using the instructions 325 for a respective topic 310 of an LLM agent, the agent builder platform 302 may coordinate with an LLM service to establish a first LLM for evaluating inputs and outputs to an LLM agent in accordance with the instructions 325. Moreover, the agent builder platform 302 may establish an LLM agent that is associated with a second LLM. That is, the agent builder platform 302 may utilize the instructions 325 to configure the second LLM associated with the LLM agent to obtain inputs and generate responses and to configure the first LLM for evaluation of the LLM agent in accordance with the techniques of the present disclosure. Moreover, the agent builder platform 302 may integrate the first LLM with one or more LLM agent frameworks such that an LLM service is configured to use the first LLM to monitor and evaluate LLM agents in real-time.

Based on an LLM agent being established, a user may interact with the LLM agent within a conversation window 330 of the user interface 300 of the agent builder platform 302. In some cases, within the conversation window 330, an agent introduction 335 for a respective LLM agent (e.g., the LLM agent that the user will interact with) may be displayed. In some cases, the agent introduction 335 may indicate how a respective user can use the LLM agent. Further, the agent introduction 335 may be based on the description 315 and the scope 320 of a topic 310 of the respective LLM agent. For example, the agent introduction 335 may display the description 315 and the scope 320 of the topic 310 of the respective LLM agent to enable a user to determine the capabilities of the respective LLM agent. Utilizing the conversation window 330, a user may input a user message 340 within a textual input box 345. For example, based on viewing the agent introduction 335, a user may input the user message 340 to prompt or query the respective LLM agent.

Based on the user message 340 being input via the conversation window 330, the agent builder platform 302 may display, via an interface 350, the operations of the LLM agent that the user is interacting with within the conversation window 330. In some cases, the interface 350 may display the user message 340 and then a selected topic 355 (e.g., the topic 310 of the LLM agent). Within the selected topic 355, the agent builder platform 302 may display an indication of the one or more instructions 360 for the LLM agent, the one or more actions 365 that the LLM agent may perform, or both. The one or more instructions 360 may indicate a set of instructions that an LLM associated with an LLM agent may follow to perform the one or more actions 365. Further, the interface 350 may indicate a selected action 370 that the LLM agent performed and an input 375 to the LLM agent and an output 380 from the action based on the LLM agent performing the selected action 370. The interface may also indicate the agent response 385 that is displayed to the user within the conversation window 330.

In some cases, such use of the interface 350 may enable users to view how an LLM agent utilizes the user message 340 to generate the agent response 385. Thus, the user interface 300 of the agent builder platform 302 may ensure a relatively simplistic way for users to view the evaluation of LLM agents for further analysis. In some cases, the agent builder platform 302 may enable users to annotate conversations or interactions to enhance the training of an LLM for evaluation. Further, the agent builder platform 302 may establish a system for sharing anonymized correction data to improve overall AI alignment. For example, since the agent builder platform 302 may be a multi-tenant platform, tenants utilizing the agent builder platform 302 may be able to utilize instructions for LLM agents and for LLMs for evaluation of LLM agents that are generated by other tenants. Moreover, the agent builder platform 302 may establish a system for sharing industry or tenant specific and personalized guiding principles sets. That is, tenants associated with a respective industry may be able to share and access instructions used for LLMs and LLM agents that are generated and configured by other tenants within the respective industry. Additionally, or alternatively, the agent builder platform 302 may utilize one or more APIs for integrating LLM agent architectures for LLM agents for a respective tenant. For example, the agent builder platform 302 may allow a user associated with a tenant to select a pre-configured LLM agent architecture or allow the user to use an LLM agent architecture configured outside of the agent builder platform 302.

Moreover, the agent builder platform 302 may enable users to configure one or more models (e.g., LLMs) for multi-agent systems to provide support for relatively complex AI ecosystems. For example, in accordance with the techniques of the present disclosure, a user may establish, via the agent builder platform 302, multiple LLM agents that can interact with each other and users and a user can establish one or more LLMs for evaluating the inputs and outputs to the multiple LLM agents. Therefore, the agent builder platform 302 may aid users in ensuring that both inputs to LLM agents and outputs from LLM agents are in accordance with a set of instructions even when the interactions are between different LLM agents.

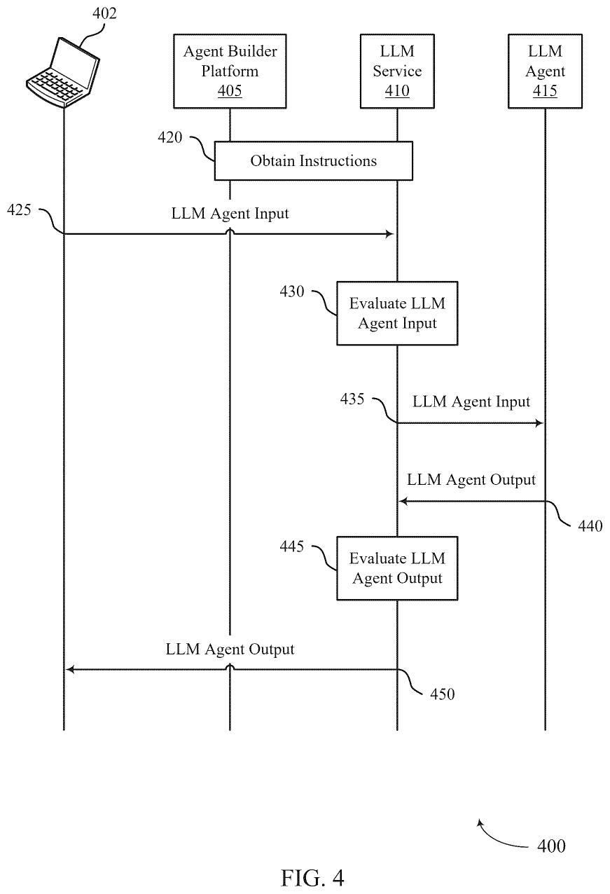

Thus, the techniques of the present disclosure may ensure that users can configure LLM agents in an effective and reliable manner. Moreover, the techniques of the present disclosure may enable users to interact with the configured LLM agents in a manner that ensures efficient, reliable, and accurate interactions due to monitoring the LLM agent inputs and outputs via an LLM. Further descriptions of the techniques of the present disclosure may be described elsewhere herein, such as with reference to FIG. 4.

FIG. 4 shows an example of a process flow 400 that supports automated agent behavior control using LLMs in accordance with aspects of the present disclosure. In some examples, the process flow 400 may implement or be implemented by the system 100, the computing system 200, the user interface 300, or any combination thereof. For example, the process flow 400 may include a computing device 402, an agent builder platform 405, an LLM service 410, and an LLM agent 415, which may be examples of devices described herein with reference to FIGS. 1 through 3.

In the following description of the process flow 400, the operations between the computing device 402, the agent builder platform 405, the LLM service 410, and the LLM agent 415 may be performed in different orders or at different times. Some operations may also be left out of the process flow 400, or other operations may be added. Although the computing device 402, the agent builder platform 405, the LLM service 410, and the LLM agent 415 are shown performing the operations of the process flow 400, some aspects of some operations may also be performed by one or more other wireless devices.

At 420, an agent builder platform 405 may obtain, via a user interface, a set of instructions for a first LLM associated with the LLM service 410. The first LLM may be configured for LLM agent 415 evaluation, to evaluate both one or more inputs to one or more LLM agents 415 and outputs of the one or more LLM agents 415 that are in response to the one or more inputs. The one or more LLM agents 415 may be established by the agent builder platform 405 and the one or more LLM agents 415 may be associated with a first tenant of a set of tenants utilizing the agent builder platform 405. In some examples, the set of instructions for the first LLM may be associated with the first tenant based on the set of instructions being for evaluation of the one or more LLM agents 415 associated with the first tenant. Additionally, or alternatively, the set of instructions for the first LLM may include information from a data platform associated with the first tenant based on the set of instructions being associated with the first tenant.

In some cases, a third LLM may generate a set of training data for training the first LLM for the LLM agent 415 evaluation. The generation of the set of training data may be based on obtaining the set of instructions for the first LLM. In some other cases, the agent builder platform 405 may obtain, via the user interface, a chat history that includes a previous set of messages from the one or more LLM agents 415. One or more messages of the previous set of messages may include an annotation indicating whether the one or more messages are in accordance with the set of instructions.

At 425, the first LLM agent 415 may obtain, from a user associated with computing device 402 associated with the first tenant, an input to the first LLM agent 415. The first LLM agent 415 may utilize a second LLM that is different from the first LLM, where the second LLM is configured to perform one or more operations associated with the first LLM agent 415.

At 430, the LLM service 410 may monitor, via the first LLM, the input to the first LLM agent 415 to evaluate whether the input to the first LLM agent 415 is in accordance with a set of instructions. In some examples, monitoring the input to the first LLM agent 415 may be based on obtaining a chat history. In some other examples, monitoring the input to the first LLM agent 415 may include evaluating metadata associated with the input from the user associated with computing device 402 associated with the first tenant. In some cases, the first LLM may monitor the input to the first LLM agent 415 in real-time. Additionally, or alternatively, monitoring the input may include the LLM service 410 obtaining, from the first LLM, a positive indication based on the evaluation of the input to the first LLM agent 415 indicating that the input is in accordance with the set of instructions, or a negative indication based on the evaluation of the input to the first LLM agent 415 indicating that the input is not in accordance with the set of instructions.

In some cases, the LLM service 410 may obtain, from the first LLM, an indication of one or more actions for the user associated with computing device 402 associated with the first tenant to perform to generate a second input that is in accordance with the set of instructions based on obtaining the negative indication for the input to the first LLM agent 415. Further, the LLM service 410 may output, to the user associated with computing device 402 associated with the first tenant, the negative indication and the indication of the one or more actions for the user to generate the second input.

At 435, the LLM service 410 may output, to the second LLM associated with the first LLM agent 415, the input from the user associated with computing device 402 based on evaluation of the input. In some examples, outputting the input from the user associated with computing device 402 to the second LLM associated with the first LLM agent 415 may be based on obtaining the positive indication from the first LLM.

At 440, the LLM service 410 may obtain, from the second LLM associated with the first LLM agent 415, an output that is in response to the input from the user associated with computing device 402. At 445, the LLM service 410 may monitor, via the first LLM, the output of the first LLM agent 415 to evaluate whether the output from the first LLM agent 415 is in accordance with a set of instructions. In some examples, monitoring the output of the first LLM agent 415 may be based on obtaining a chat history. In some other examples, monitoring the output from the first LLM agent 415 may include evaluating metadata associated with the output of the first LLM agent 415 in response to the input from the user associated with computing device 402 associated with the first tenant. In some cases, the first LLM may monitor the output of the first LLM agent 415 in real-time.

Additionally, or alternatively, monitoring the output may include the LLM service 410 obtaining, from the first LLM, a positive indication based on the evaluation of the output of the first LLM agent 415 indicating that the output is in accordance with the set of instructions, or a negative indication based on the evaluation of the output of the first LLM agent 415 indicating that the output is not in accordance with the set of instructions. Further, the LLM service 410 may obtain, from the first LLM, an indication of one or more actions for the second LLM to perform to generate a second output that is in accordance with the set of instructions based on obtaining the negative indication for the output of the first LLM agent 415. In some examples, the negative indication and the indication of the one or more actions for the second LLM to generate the second output may be outputted to the second LLM associated with the first LLM agent 415.

At 450, the LLM service 410 may output, to the user associated with computing device 402 associated with the first tenant, the output from the first LLM agent 415 may be outputted based on evaluation of the output. In some examples, outputting the output from the second LLM associated with the first LLM agent 415 to the user associated with computing device 402 may be based on the LLM service 410 obtaining the positive indication from the first LLM.

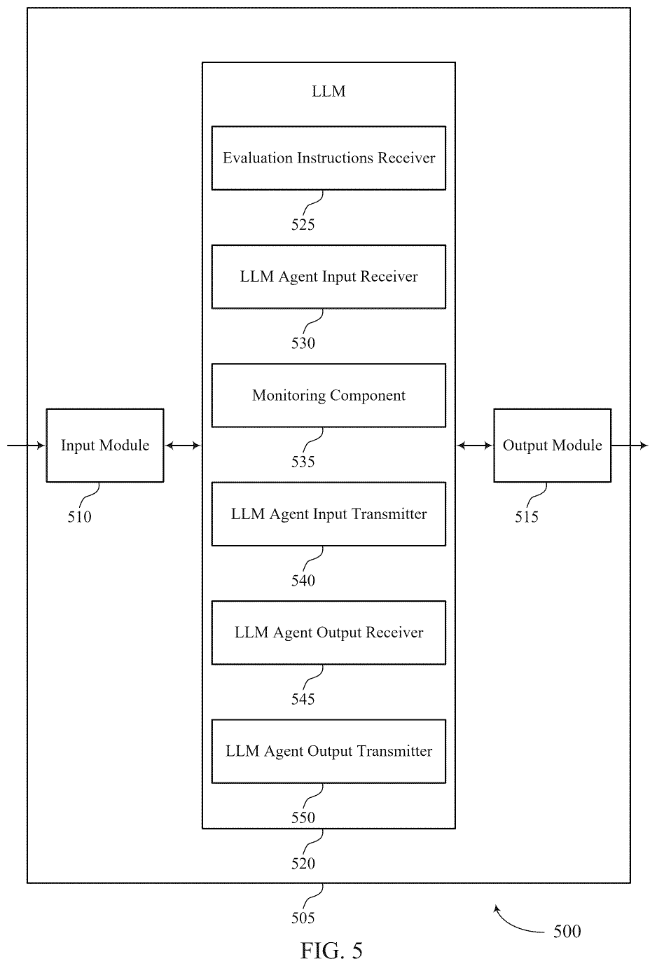

FIG. 5 shows a block diagram 500 of a device 505 that supports automated agent behavior control using LLMs in accordance with aspects of the present disclosure. The device 505 may include an input module 510, an output module 515, and an LLM 520. The device 505, or one or more components of the device 505 (e.g., the input module 510, the output module 515, the LLM 520), may include at least one processor, which may be coupled with at least one memory, to support the described techniques. Each of these components may be in communication with one another (e.g., via one or more buses).

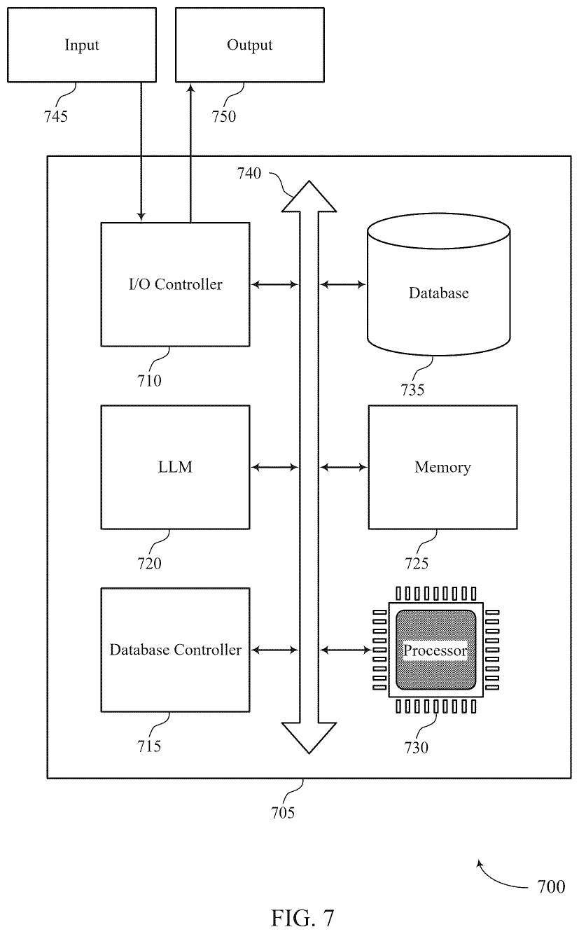

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the LLM 520 to support automated agent behavior control using LLMs. In some cases, the input module 510 may be a component of an input/output (I/O) controller 710 as described with reference to FIG. 7.

The output module 515 may manage output signals for the device 505. For example, the output module 515 may receive signals from other components of the device 505, such as the LLM 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the LLM 520 may include an evaluation instructions receiver 525, an LLM agent input receiver 530, a monitoring component 535, an LLM agent input transmitter 540, an LLM agent output receiver 545, an LLM agent output transmitter 550, or any combination thereof. In some examples, the LLM 520, or various components thereof, may be configured to perform various operations (e.g., receiving, monitoring, transmitting) using or otherwise in cooperation with the input module 510, the output module 515, or both. For example, the LLM 520 may receive information from the input module 510, send information to the output module 515, or be integrated in combination with the input module 510, the output module 515, or both to receive information, transmit information, or perform various other operations as described herein.

The LLM 520 may support agent control via an LLM in accordance with examples as disclosed herein. The evaluation instructions receiver 525 may be configured to support obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform. The LLM agent input receiver 530 may be configured to support obtaining, from a first user associated with the first tenant, an input to a first LLM agent, the first LLM agent utilizing a second LLM that is different from the first LLM, where the second LLM is configured to perform one or more operations associated with the first LLM agent. The monitoring component 535 may be configured to support monitoring, via the first LLM, the input to the first LLM agent to evaluate whether the input to the first LLM agent is in accordance with the set of instructions. The LLM agent input transmitter 540 may be configured to support outputting, to the second LLM associated with the first LLM agent, the input from the first user based on evaluation of the input. The LLM agent output receiver 545 may be configured to support obtaining, from the second LLM associated with the first LLM agent, an output that is in response to the input from the first user. The monitoring component 535 may be configured to support monitoring, via the first LLM, the output of the first LLM agent to evaluate whether the output from the first LLM agent is in accordance with the set of instructions. The LLM agent output transmitter 550 may be configured to support outputting, to the first user associated with the first tenant, the output from the first LLM agent based on evaluation of the output.

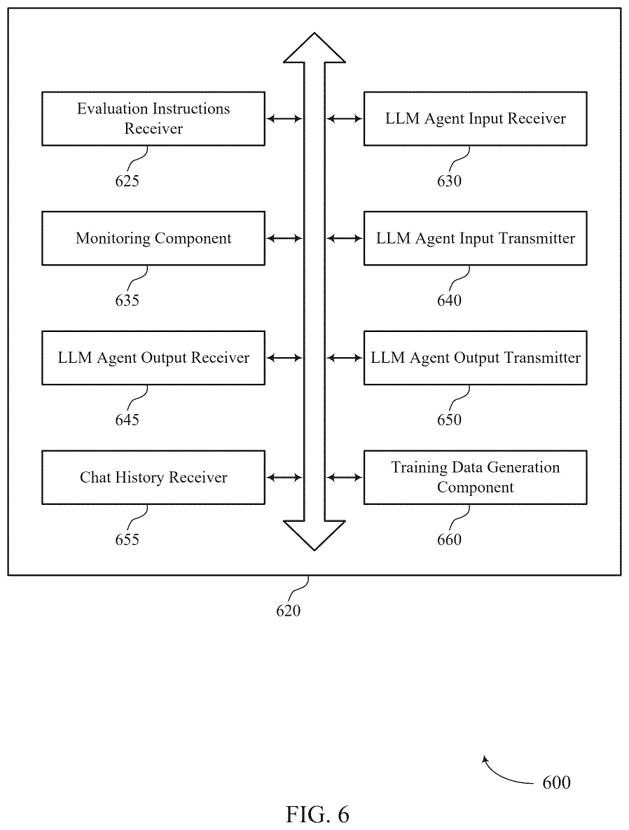

FIG. 6 shows a block diagram 600 of an LLM 620 that supports automated agent behavior control using LLMs in accordance with aspects of the present disclosure. The LLM 620 may be an example of aspects of an LLM or an LLM 520, or both, as described herein. The LLM 620, or various components thereof, may be an example of means for performing various aspects of automated agent behavior control using LLMs as described herein. For example, the LLM 620 may include an evaluation instructions receiver 625, an LLM agent input receiver 630, a monitoring component 635, an LLM agent input transmitter 640, an LLM agent output receiver 645, an LLM agent output transmitter 650, a chat history receiver 655, a training data generation component 660, or any combination thereof. Each of these components, or components of subcomponents thereof (e.g., one or more processors, one or more memories), may communicate, directly or indirectly, with one another (e.g., via one or more buses).

The LLM 620 may support agent control via an LLM in accordance with examples as disclosed herein. The evaluation instructions receiver 625 may be configured to support obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform. The LLM agent input receiver 630 may be configured to support obtaining, from a first user associated with the first tenant, an input to a first LLM agent, the first LLM agent utilizing a second LLM that is different from the first LLM, where the second LLM is configured to perform one or more operations associated with the first LLM agent. The monitoring component 635 may be configured to support monitoring, via the first LLM, the input to the first LLM agent to evaluate whether the input to the first LLM agent is in accordance with the set of instructions. The LLM agent input transmitter 640 may be configured to support outputting, to the second LLM associated with the first LLM agent, the input from the first user based on evaluation of the input. The LLM agent output receiver 645 may be configured to support obtaining, from the second LLM associated with the first LLM agent, an output that is in response to the input from the first user. In some examples, the monitoring component 635 may be configured to support monitoring, via the first LLM, the output of the first LLM agent to evaluate whether the output from the first LLM agent is in accordance with the set of instructions. The LLM agent output transmitter 650 may be configured to support outputting, to the first user associated with the first tenant, the output from the first LLM agent based on evaluation of the output.

In some examples, the chat history receiver 655 may be configured to support obtaining, via the user interface of the agent builder platform, a chat history including a previous set of messages from the one or more LLM agents, one or more messages of the previous set of messages including an annotation indicating whether the one or more messages are in accordance with the set of instructions, where monitoring the input to the first LLM agent and the output of the first LLM agent is based on obtaining the chat history.

In some examples, the training data generation component 660 may be configured to support generating, via a third LLM configured for data generation, a set of training data for training the first LLM for the LLM agent evaluation, where generating the set of training data is based on obtaining the set of instructions for the first LLM.

In some examples, to support monitoring the input, the monitoring component 635 may be configured to support obtaining, from the first LLM, a positive indication based on the evaluation of the input to the first LLM agent indicating that the input is in accordance with the set of instructions, or a negative indication based on the evaluation of the input to the first LLM agent indicating that the input is not in accordance with the set of instructions.

In some examples, the monitoring component 635 may be configured to support obtaining, from the first LLM, an indication of one or more actions for the first user associated with the first tenant to perform to generate a second input that is in accordance with the set of instructions based on obtaining the negative indication for the input to the first LLM agent. In some examples, the monitoring component 635 may be configured to support outputting, to the first user associated with the first tenant, the negative indication and the indication of the one or more actions for the first user to generate the second input.

In some examples, outputting the input from the first user to the second LLM associated with the first LLM agent is based on obtaining the positive indication from the first LLM.

In some examples, to support monitoring the output, the monitoring component 635 may be configured to support obtaining, from the first LLM, a positive indication based on the evaluation of the output of the first LLM agent indicating that the output is in accordance with the set of instructions, or a negative indication based on the evaluation of the output of the first LLM agent indicating that the output is not in accordance with the set of instructions.

In some examples, the monitoring component 635 may be configured to support obtaining, from the first LLM, an indication of one or more actions for the second LLM to perform to generate a second output that is in accordance with the set of instructions based on obtaining the negative indication for the output of the first LLM agent. In some examples, the monitoring component 635 may be configured to support outputting, to the second LLM associated with the first LLM agent, the negative indication and the indication of the one or more actions for the second LLM to generate the second output.

In some examples, outputting the output from the second LLM associated with the first LLM agent to the first user is based on obtaining the positive indication from the first LLM.

In some examples, the first LLM monitors the input to the first LLM agent and the output of the first LLM agent in real-time.

In some examples, the set of instructions for the first LLM are associated with the first tenant based on the set of instructions being for evaluation of the one or more LLM agents associated with the first tenant.

In some examples, the set of instructions for the first LLM includes information from a data platform associated with the first tenant based on the set of instructions being associated with the first tenant.

In some examples, monitoring the input to the first LLM agent includes evaluating metadata associated with the input from the first user associated with the first tenant and monitoring the output from the first LLM agent includes evaluating metadata associated with the output of the first LLM agent in response to the input from the first user associated with the first tenant.

FIG. 7 shows a diagram of a system 700 including a device 705 that supports automated agent behavior control using LLMs in accordance with aspects of the present disclosure. The device 705 may be an example of or include components of a device 505 as described herein. The device 705 may include components for bi-directional data communications including components for transmitting and receiving communications, such as an LLM 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting automated agent behavior control using LLMs). The processor 730 may be an example of a single processor or multiple processors. For example, the device 705 may include one or more processors 730.

The LLM 720 may support agent control via an LLM in accordance with examples as disclosed herein. For example, the LLM 720 may be configured to support obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform. The LLM 720 may be configured to support obtaining, from a first user associated with the first tenant, an input to a first LLM agent, the first LLM agent utilizing a second LLM that is different from the first LLM, where the second LLM is configured to perform one or more operations associated with the first LLM agent. The LLM 720 may be configured to support monitoring, via the first LLM, the input to the first LLM agent to evaluate whether the input to the first LLM agent is in accordance with the set of instructions. The LLM 720 may be configured to support outputting, to the second LLM associated with the first LLM agent, the input from the first user based on evaluation of the input. The LLM 720 may be configured to support obtaining, from the second LLM associated with the first LLM agent, an output that is in response to the input from the first user. The LLM 720 may be configured to support monitoring, via the first LLM, the output of the first LLM agent to evaluate whether the output from the first LLM agent is in accordance with the set of instructions. The LLM 720 may be configured to support outputting, to the first user associated with the first tenant, the output from the first LLM agent based on evaluation of the output.

By including or configuring the LLM 720 in accordance with examples as described herein, the device 705 may support techniques for monitoring the inputs and outputs to LLM agents to support improved user experiences, improved accuracy, reliability, and relevance of LLM agent outputs, improved reliability and efficiency of LLM agents, and more efficient utilization of computing resources associated with LLMs.

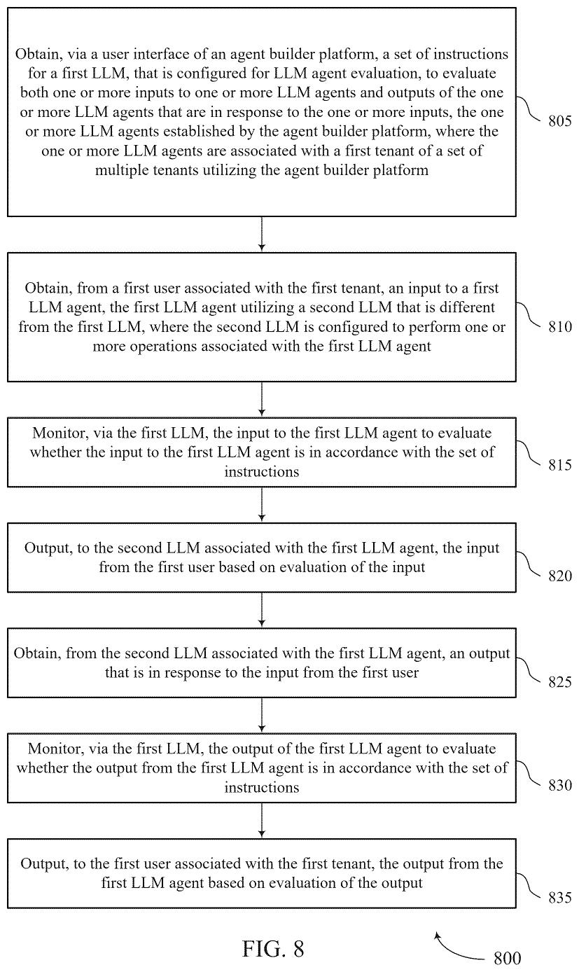

FIG. 8 shows a flowchart illustrating a method 800 that supports automated agent behavior control using LLMs in accordance with aspects of the present disclosure. The operations of the method 800 may be implemented by an LLM Service or its components as described herein. For example, the operations of the method 800 may be performed by an LLM Service as described with reference to FIGS. 1 through 7. In some examples, an LLM Service may execute a set of instructions to control the functional elements of the LLM Service to perform the described functions. Additionally, or alternatively, the LLM Service may perform aspects of the described functions using special-purpose hardware.

At 805, the method may include obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform. The operations of 805 may be performed in accordance with examples as disclosed herein. In some examples, aspects of the operations of 805 may be performed by an evaluation instructions receiver 625 as described with reference to FIG. 6.

At 810, the method may include obtaining, from a first user associated with the first tenant, an input to a first LLM agent, the first LLM agent utilizing a second LLM that is different from the first LLM, where the second LLM is configured to perform one or more operations associated with the first LLM agent. The operations of 810 may be performed in accordance with examples as disclosed herein. In some examples, aspects of the operations of 810 may be performed by an LLM agent input receiver 630 as described with reference to FIG. 6.

At 815, the method may include monitoring, via the first LLM, the input to the first LLM agent to evaluate whether the input to the first LLM agent is in accordance with the set of instructions. The operations of 815 may be performed in accordance with examples as disclosed herein. In some examples, aspects of the operations of 815 may be performed by a monitoring component 635 as described with reference to FIG. 6.

At 820, the method may include outputting, to the second LLM associated with the first LLM agent, the input from the first user based on evaluation of the input. The operations of 820 may be performed in accordance with examples as disclosed herein. In some examples, aspects of the operations of 820 may be performed by an LLM agent input transmitter 640 as described with reference to FIG. 6.

At 825, the method may include obtaining, from the second LLM associated with the first LLM agent, an output that is in response to the input from the first user. The operations of 825 may be performed in accordance with examples as disclosed herein. In some examples, aspects of the operations of 825 may be performed by an LLM agent output receiver 645 as described with reference to FIG. 6.

At 830, the method may include monitoring, via the first LLM, the output of the first LLM agent to evaluate whether the output from the first LLM agent is in accordance with the set of instructions. The operations of 830 may be performed in accordance with examples as disclosed herein. In some examples, aspects of the operations of 830 may be performed by a monitoring component 635 as described with reference to FIG. 6.

At 835, the method may include outputting, to the first user associated with the first tenant, the output from the first LLM agent based on evaluation of the output. The operations of 835 may be performed in accordance with examples as disclosed herein. In some examples, aspects of the operations of 835 may be performed by an LLM agent output transmitter 650 as described with reference to FIG. 6.

A method for agent control via an LLM by an apparatus is described. The method may include obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform, obtaining, from a first user associated with the first tenant, an input to a first LLM agent, the first LLM agent utilizing a second LLM that is different from the first LLM, where the second LLM is configured to perform one or more operations associated with the first LLM agent, monitoring, via the first LLM, the input to the first LLM agent to evaluate whether the input to the first LLM agent is in accordance with the set of instructions, outputting, to the second LLM associated with the first LLM agent, the input from the first user based on evaluation of the input, obtaining, from the second LLM associated with the first LLM agent, an output that is in response to the input from the first user, monitoring, via the first LLM, the output of the first LLM agent to evaluate whether the output from the first LLM agent is in accordance with the set of instructions, and outputting, to the first user associated with the first tenant, the output from the first LLM agent based on evaluation of the output.

An apparatus for agent control via an LLM is described. The apparatus may include one or more memories storing processor executable code, and one or more processors coupled with the one or more memories. The one or more processors may individually or collectively be operable to execute the code to cause the apparatus to obtain, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform, obtain, from a first user associated with the first tenant, an input to a first LLM agent, the first LLM agent utilizing a second LLM that is different from the first LLM, where the second LLM is configured to perform one or more operations associated with the first LLM agent, monitor, via the first LLM, the input to the first LLM agent to evaluate whether the input to the first LLM agent is in accordance with the set of instructions, output, to the second LLM associated with the first LLM agent, the input from the first user based on evaluation of the input, obtain, from the second LLM associated with the first LLM agent, an output that is in response to the input from the first user, monitor, via the first LLM, the output of the first LLM agent to evaluate whether the output from the first LLM agent is in accordance with the set of instructions, and output, to the first user associated with the first tenant, the output from the first LLM agent based on evaluation of the output.

Another apparatus for agent control via an LLM is described. The apparatus may include means for obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform, means for obtaining, from a first user associated with the first tenant, an input to a first LLM agent, the first LLM agent utilizing a second LLM that is different from the first LLM, where the second LLM is configured to perform one or more operations associated with the first LLM agent, means for monitoring, via the first LLM, the input to the first LLM agent to evaluate whether the input to the first LLM agent is in accordance with the set of instructions, means for outputting, to the second LLM associated with the first LLM agent, the input from the first user based on evaluation of the input, means for obtaining, from the second LLM associated with the first LLM agent, an output that is in response to the input from the first user, means for monitoring, via the first LLM, the output of the first LLM agent to evaluate whether the output from the first LLM agent is in accordance with the set of instructions, and means for outputting, to the first user associated with the first tenant, the output from the first LLM agent based on evaluation of the output.

A non-transitory computer-readable medium storing code for agent control via an LLM is described. The code may include instructions executable by one or more processors to obtain, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, where the one or more LLM agents are associated with a first tenant of a set of multiple tenants utilizing the agent builder platform, obtain, from a first user associated with the first tenant, an input to a first LLM agent, the first LLM agent utilizing a second LLM that is different from the first LLM, where the second LLM is configured to perform one or more operations associated with the first LLM agent, monitor, via the first LLM, the input to the first LLM agent to evaluate whether the input to the first LLM agent is in accordance with the set of instructions, output, to the second LLM associated with the first LLM agent, the input from the first user based on evaluation of the input, obtain, from the second LLM associated with the first LLM agent, an output that is in response to the input from the first user, monitor, via the first LLM, the output of the first LLM agent to evaluate whether the output from the first LLM agent is in accordance with the set of instructions, and output, to the first user associated with the first tenant, the output from the first LLM agent based on evaluation of the output.

Some examples of the method, apparatus, and non-transitory computer-readable medium described herein may further include operations, features, means, or instructions for obtaining, via the user interface of the agent builder platform, a chat history including a previous set of messages from the one or more LLM agents, one or more messages of the previous set of messages including an annotation indicating whether the one or more messages may be in accordance with the set of instructions, where monitoring the input to the first LLM agent and the output of the first LLM agent may be based on obtaining the chat history.

Some examples of the method, apparatus, and non-transitory computer-readable medium described herein may further include operations, features, means, or instructions for generating, via a third LLM configured for data generation, a set of training data for training the first LLM for the LLM agent evaluation, where generating the set of training data may be based on obtaining the set of instructions for the first LLM.

In some examples of the method, apparatus, and non-transitory computer-readable medium described herein, monitoring the input may include operations, features, means, or instructions for obtaining, from the first LLM, a positive indication based on the evaluation of the input to the first LLM agent indicating that the input may be in accordance with the set of instructions, or a negative indication based on the evaluation of the input to the first LLM agent indicating that the input may be not in accordance with the set of instructions.

Some examples of the method, apparatus, and non-transitory computer-readable medium described herein may further include operations, features, means, or instructions for obtaining, from the first LLM, an indication of one or more actions for the first user associated with the first tenant to perform to generate a second input that may be in accordance with the set of instructions based on obtaining the negative indication for the input to the first LLM agent and outputting, to the first user associated with the first tenant, the negative indication and the indication of the one or more actions for the first user to generate the second input.

Some examples of the method, apparatus, and non-transitory computer-readable medium described herein may further include operations, features, means, or instructions for outputting the input from the first user to the second LLM associated with the first LLM agent may be based on obtaining the positive indication from the first LLM.

In some examples of the method, apparatus, and non-transitory computer-readable medium described herein, monitoring the output may include operations, features, means, or instructions for obtaining, from the first LLM, a positive indication based on the evaluation of the output of the first LLM agent indicating that the output may be in accordance with the set of instructions, or a negative indication based on the evaluation of the output of the first LLM agent indicating that the output may be not in accordance with the set of instructions.

Some examples of the method, apparatus, and non-transitory computer-readable medium described herein may further include operations, features, means, or instructions for obtaining, from the first LLM, an indication of one or more actions for the second LLM to perform to generate a second output that may be in accordance with the set of instructions based on obtaining the negative indication for the output of the first LLM agent and outputting, to the second LLM associated with the first LLM agent, the negative indication and the indication of the one or more actions for the second LLM to generate the second output.

Some examples of the method, apparatus, and non-transitory computer-readable medium described herein may further include operations, features, means, or instructions for outputting the output from the second LLM associated with the first LLM agent to the first user may be based on obtaining the positive indication from the first LLM.

In some examples of the method, apparatus, and non-transitory computer-readable medium described herein, the first LLM monitors the input to the first LLM agent and the output of the first LLM agent in real-time.

In some examples of the method, apparatus, and non-transitory computer-readable medium described herein, the set of instructions for the first LLM may be associated with the first tenant based on the set of instructions being for evaluation of the one or more LLM agents associated with the first tenant.

In some examples of the method, apparatus, and non-transitory computer-readable medium described herein, the set of instructions for the first LLM includes information from a data platform associated with the first tenant based on the set of instructions being associated with the first tenant.

Some examples of the method, apparatus, and non-transitory computer-readable medium described herein may further include operations, features, means, or instructions for monitoring the input to the first LLM agent includes evaluating metadata associated with the input from the first user associated with the first tenant and monitoring the output from the first LLM agent includes evaluating metadata associated with the output of the first LLM agent in response to the input from the first user associated with the first tenant.

The following provides an overview of aspects of the present disclosure:
Aspect 1: A method for agent control via an LLM, comprising: obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, wherein the one or more LLM agents are associated with a first tenant of a plurality of tenants utilizing the agent builder platform; obtaining, from a first user associated with the first tenant, an input to a first LLM agent, the first LLM agent utilizing a second LLM that is different from the first LLM, wherein the second LLM is configured to perform one or more operations associated with the first LLM agent; monitoring, via the first LLM, the input to the first LLM agent to evaluate whether the input to the first LLM agent is in accordance with the set of instructions; outputting, to the second LLM associated with the first LLM agent, the input from the first user based at least in part on evaluation of the input; obtaining, from the second LLM associated with the first LLM agent, an output that is in response to the input from the first user; monitoring, via the first LLM, the output of the first LLM agent to evaluate whether the output from the first LLM agent is in accordance with the set of instructions; and outputting, to the first user associated with the first tenant, the output from the first LLM agent based at least in part on evaluation of the output.
Aspect 2: The method of aspect 1, further comprising: obtaining, via the user interface of the agent builder platform, a chat history comprising a previous set of messages from the one or more LLM agents, one or more messages of the previous set of messages comprising an annotation indicating whether the one or more messages are in accordance with the set of instructions, wherein monitoring the input to the first LLM agent and the output of the first LLM agent is based at least in part on obtaining the chat history.
Aspect 3: The method of any of aspects 1 through 2, further comprising: generating, via a third LLM configured for data generation, a set of training data for training the first LLM for the LLM agent evaluation, wherein generating the set of training data is based at least in part on obtaining the set of instructions for the first LLM.
Aspect 4: The method of any of aspects 1 through 3, wherein monitoring the input comprises: obtaining, from the first LLM, a positive indication based at least in part on the evaluation of the input to the first LLM agent indicating that the input is in accordance with the set of instructions, or a negative indication based at least in part on the evaluation of the input to the first LLM agent indicating that the input is not in accordance with the set of instructions.
Aspect 5: The method of aspect 4, further comprising: obtaining, from the first LLM, an indication of one or more actions for the first user associated with the first tenant to perform to generate a second input that is in accordance with the set of instructions based at least in part on obtaining the negative indication for the input to the first LLM agent; and outputting, to the first user associated with the first tenant, the negative indication and the indication of the one or more actions for the first user to generate the second input.
Aspect 6: The method of any of aspects 4 through 5, wherein outputting the input from the first user to the second LLM associated with the first LLM agent is based at least in part on obtaining the positive indication from the first LLM.
Aspect 7: The method of any of aspects 1 through 6, wherein monitoring the output comprises: obtaining, from the first LLM, a positive indication based at least in part on the evaluation of the output of the first LLM agent indicating that the output is in accordance with the set of instructions, or a negative indication based at least in part on the evaluation of the output of the first LLM agent indicating that the output is not in accordance with the set of instructions.
Aspect 8: The method of aspect 7, further comprising: obtaining, from the first LLM, an indication of one or more actions for the second LLM to perform to generate a second output that is in accordance with the set of instructions based at least in part on obtaining the negative indication for the output of the first LLM agent; and outputting, to the second LLM associated with the first LLM agent, the negative indication and the indication of the one or more actions for the second LLM to generate the second output.
Aspect 9: The method of any of aspects 7 through 8, wherein outputting the output from the second LLM associated with the first LLM agent to the first user is based at least in part on obtaining the positive indication from the first LLM.
Aspect 10: The method of any of aspects 1 through 9, wherein the first LLM monitors the input to the first LLM agent and the output of the first LLM agent in real-time.
Aspect 11: The method of any of aspects 1 through 10, wherein the set of instructions for the first LLM are associated with the first tenant based at least in part on the set of instructions being for evaluation of the one or more LLM agents associated with the first tenant.
Aspect 12: The method of aspect 11, wherein the set of instructions for the first LLM comprises information from a data platform associated with the first tenant based at least in part on the set of instructions being associated with the first tenant.
Aspect 13: The method of any of aspects 1 through 12, wherein monitoring the input to the first LLM agent comprises evaluating metadata associated with the input from the first user associated with the first tenant and monitoring the output from the first LLM agent comprises evaluating metadata associated with the output of the first LLM agent in response to the input from the first user associated with the first tenant.
Aspect 14: An apparatus for agent control via an LLM, comprising one or more memories storing processor-executable code, and one or more processors coupled with the one or more memories and individually or collectively operable to execute the code to cause the apparatus to perform a method of any of aspects 1 through 13.
Aspect 15: An apparatus for agent control via an LLM, comprising at least one means for performing a method of any of aspects 1 through 13.
Aspect 16: A non-transitory computer-readable medium storing code for agent control via an LLM, the code comprising instructions executable by one or more processors to perform a method of any of aspects 1 through 13.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for agent control via a large language model (LLM), comprising:
obtaining, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, wherein the one or more LLM agents are associated with a first tenant of a plurality of tenants utilizing the agent builder platform;
obtaining, from a first user associated with the first tenant, an input to a first LLM agent, the first LLM agent utilizing a second LLM that is different from the first LLM, wherein the second LLM is configured to perform one or more operations associated with the first LLM agent;
monitoring, via the first LLM, the input to the first LLM agent to evaluate whether the input to the first LLM agent is in accordance with the set of instructions;
outputting, to the second LLM associated with the first LLM agent, the input from the first user based at least in part on evaluation of the input;
obtaining, from the second LLM associated with the first LLM agent, an output that is in response to the input from the first user;
monitoring, via the first LLM, the output of the first LLM agent to evaluate whether the output from the first LLM agent is in accordance with the set of instructions; and
outputting, to the first user associated with the first tenant, the output from the first LLM agent based at least in part on evaluation of the output.

2. The method of claim 1, further comprising:
obtaining, via the user interface of the agent builder platform, a chat history comprising a previous set of messages from the one or more LLM agents, one or more messages of the previous set of messages comprising an annotation indicating whether the one or more messages are in accordance with the set of instructions, wherein monitoring the input to the first LLM agent and the output of the first LLM agent is based at least in part on obtaining the chat history.

3. The method of claim 1, further comprising:
generating, via a third LLM configured for data generation, a set of training data for training the first LLM for the LLM agent evaluation, wherein generating the set of training data is based at least in part on obtaining the set of instructions for the first LLM.

4. The method of claim 1, wherein monitoring the input comprises:
obtaining, from the first LLM, a positive indication based at least in part on the evaluation of the input to the first LLM agent indicating that the input is in accordance with the set of instructions, or a negative indication based at least in part on the evaluation of the input to the first LLM agent indicating that the input is not in accordance with the set of instructions.

5. The method of claim 4, further comprising:
obtaining, from the first LLM, an indication of one or more actions for the first user associated with the first tenant to perform to generate a second input that is in accordance with the set of instructions based at least in part on obtaining the negative indication for the input to the first LLM agent; and
outputting, to the first user associated with the first tenant, the negative indication and the indication of the one or more actions for the first user to generate the second input.

6. The method of claim 4, wherein outputting the input from the first user to the second LLM associated with the first LLM agent is based at least in part on obtaining the positive indication from the first LLM.

7. The method of claim 1, wherein monitoring the output comprises:
obtaining, from the first LLM, a positive indication based at least in part on the evaluation of the output of the first LLM agent indicating that the output is in accordance with the set of instructions, or a negative indication based at least in part on the evaluation of the output of the first LLM agent indicating that the output is not in accordance with the set of instructions.

8. The method of claim 7, further comprising:
obtaining, from the first LLM, an indication of one or more actions for the second LLM to perform to generate a second output that is in accordance with the set of instructions based at least in part on obtaining the negative indication for the output of the first LLM agent; and
outputting, to the second LLM associated with the first LLM agent, the negative indication and the indication of the one or more actions for the second LLM to generate the second output.

9. The method of claim 7, wherein outputting the output from the second LLM associated with the first LLM agent to the first user is based at least in part on obtaining the positive indication from the first LLM.

10. The method of claim 1, wherein the first LLM monitors the input to the first LLM agent and the output of the first LLM agent in real-time.

11. The method of claim 1, wherein the set of instructions for the first LLM are associated with the first tenant based at least in part on the set of instructions being for evaluation of the one or more LLM agents associated with the first tenant.

12. The method of claim 11, wherein the set of instructions for the first LLM comprises information from a data platform associated with the first tenant based at least in part on the set of instructions being associated with the first tenant.

13. The method of claim 1, wherein monitoring the input to the first LLM agent comprises evaluating metadata associated with the input from the first user associated with the first tenant and monitoring the output from the first LLM agent comprises evaluating metadata associated with the output of the first LLM agent in response to the input from the first user associated with the first tenant.

14. An apparatus for agent control via a large language model (LLM), comprising:
one or more memories storing processor-executable code; and
one or more processors coupled with the one or more memories and individually or collectively operable to execute the code to cause the apparatus to:
obtain, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, wherein the one or more LLM agents are associated with a first tenant of a plurality of tenants utilizing the agent builder platform;
obtain, from a first user associated with the first tenant, an input to a first LLM agent, the first LLM agent utilizing a second LLM that is different from the first LLM, wherein the second LLM is configured to perform one or more operations associated with the first LLM agent;
monitor, via the first LLM, the input to the first LLM agent to evaluate whether the input to the first LLM agent is in accordance with the set of instructions;
output, to the second LLM associated with the first LLM agent, the input from the first user based at least in part on evaluation of the input;
obtain, from the second LLM associated with the first LLM agent, an output that is in response to the input from the first user;
monitor, via the first LLM, the output of the first LLM agent to evaluate whether the output from the first LLM agent is in accordance with the set of instructions; and
output, to the first user associated with the first tenant, the output from the first LLM agent based at least in part on evaluation of the output.

15. The apparatus of claim 14, wherein the one or more processors are individually or collectively further operable to execute the code to cause the apparatus to:
obtain, via the user interface of the agent builder platform, a chat history comprising a previous set of messages from the one or more LLM agents, one or more messages of the previous set of messages comprising an annotation indicating whether the one or more messages are in accordance with the set of instructions, wherein monitoring the input to the first LLM agent and the output of the first LLM agent is based at least in part on obtaining the chat history.

16. The apparatus of claim 14, wherein the one or more processors are individually or collectively further operable to execute the code to cause the apparatus to:
generate, via a third LLM configured for data generation, a set of training data for training the first LLM for the LLM agent evaluation, wherein generating the set of training data is based at least in part on obtaining the set of instructions for the first LLM.

17. The apparatus of claim 14, wherein, to monitor the input, the one or more processors are individually or collectively operable to execute the code to cause the apparatus to:
obtain, from the first LLM, a positive indication based at least in part on the evaluation of the input to the first LLM agent indicating that the input is in accordance with the set of instructions, or a negative indication based at least in part on the evaluation of the input to the first LLM agent indicating that the input is not in accordance with the set of instructions.

18. The apparatus of claim 14, wherein, to monitor the output, the one or more processors are individually or collectively operable to execute the code to cause the apparatus to:
obtain, from the first LLM, a positive indication based at least in part on the evaluation of the output of the first LLM agent indicating that the output is in accordance with the set of instructions, or a negative indication based at least in part on the evaluation of the output of the first LLM agent indicating that the output is not in accordance with the set of instructions.

19. The apparatus of claim 14, wherein monitoring the input to the first LLM agent comprises evaluating metadata associated with the input from the first user associated with the first tenant and monitoring the output from the first LLM agent comprises evaluating metadata associated with the output of the first LLM agent in response to the input from the first user associated with the first tenant.

20. A non-transitory computer-readable medium storing code for agent control via a large language model (LLM), the code comprising instructions executable by one or more processors to:
obtain, via a user interface of an agent builder platform, a set of instructions for a first LLM, that is configured for LLM agent evaluation, to evaluate both one or more inputs to one or more LLM agents and outputs of the one or more LLM agents that are in response to the one or more inputs, the one or more LLM agents established by the agent builder platform, wherein the one or more LLM agents are associated with a first tenant of a plurality of tenants utilizing the agent builder platform;
obtain, from a first user associated with the first tenant, an input to a first LLM agent, the first LLM agent utilizing a second LLM that is different from the first LLM, wherein the second LLM is configured to perform one or more operations associated with the first LLM agent;
monitor, via the first LLM, the input to the first LLM agent to evaluate whether the input to the first LLM agent is in accordance with the set of instructions;
output, to the second LLM associated with the first LLM agent, the input from the first user based at least in part on evaluation of the input;
obtain, from the second LLM associated with the first LLM agent, an output that is in response to the input from the first user;
monitor, via the first LLM, the output of the first LLM agent to evaluate whether the output from the first LLM agent is in accordance with the set of instructions; and
output, to the first user associated with the first tenant, the output from the first LLM agent based at least in part on evaluation of the output.
